(19) United States
(12) Patent Application Publication
(10) Pub. No.: US 2013/0104242 A1
(43) Pub. Date: Apr. 25, 2013

(54) METHOD AND SYSTEM FOR FORENSIC MARKING OF DIGITAL CONTENTS

(71) Applicants: Yongseok Seo, Daejeon (KR); Jung Ho Lee, Wonju (KR); Wonyoung Yoo, Daejeon (KR); Young Ho Suh, Daejeon (KR); Sang Kwang Lee, Daejeon (KR); Jee Hyun Park, Daejeon (KR); Young-Suk Yoon, Daejeon (KR); Seungjae Lee, Daejeon (KR); Sungmin Kim, Daejeon (KR); JungHyun Kim, Daejeon (KR)

(72) Inventors: Yongseok Seo, Daejeon (KR); Jung Ho Lee, Wonju (KR); Wonyoung Yoo, Daejeon (KR); Young Ho Suh, Daejeon (KR); Sang Kwang Lee, Daejeon (KR); Jee Hyun Park, Daejeon (KR); Young-Suk Yoon, Daejeon (KR); Seungjae Lee, Daejeon (KR); Sungmin Kim, Daejeon (KR); JungHyun Kim, Daejeon (KR)

(73) Assignee: Electronics and Telecommunications Research Institute, Daejeon (KR)

(21) Appl. No.: 13/620,145

(22) Filed: Sep. 14, 2012

(30) Foreign Application Priority Data
Oct. 20, 2011 (KR) 10-2011-0107497
Jul. 18, 2012 (KR) 10-2012-0078132

(51) Int. Cl. G06F 21/24

(52) U.S. Cl. 726/26

(57) ABSTRACT

Disclosed are a forensic marking method and a forensic marking system capable of inserting in real-time a forensic mark for user information in digital contents provided online. The forensic marking method of the digital content according to an exemplary embodiment of the present disclosure includes generating a first content created by inserting a first forensic mark in an original content and a second content created by inserting a second forensic mark in the original content by a content server; transmitting the first and second contents to a client terminal by the content server; and combining fragments of the first and second contents in a combination order corresponding to user information to generate a third content by the client terminal

### CROSS-REFERENCE TO RELATED APPLICATIONS

This application is based on and claims priority from Korean Patent Application No. 10-2011-0107497, filed on Oct. 20, 2011, and Korean Patent Application No. 10-2012-0078132, filed on Jul. 18, 2012, with the Korean Intellectual Property Office, the disclosure of which is incorporated herein in its entirety by reference.

### TECHNICAL FIELD

The present disclosure relates to a technology of inserting in real-time a forensic mark in digital contents provided online.

### BACKGROUND

A forensic marking technology refers to a technology of inserting information of a seller, a copyright owner, or a purchaser in digital multimedia contents, so as to extract information inserted and identify a distributor when the contents are illegally distributed. For example, in a case where an online service provider (OSP) inserts purchaser information in contents by using a forensic mark in providing the contents, if an illegal release problem of the corresponding contents occurs, it is possible to call an initial distributor by identifying the forensic mark from the released contents.

However, a process of inserting the forensic mark in the digital contents requires a considerable amount of operations and a lot of time since the process passes through a step of decoding the corresponding contents to insert the forensic mark and then encoding back the corresponding contents. When a download service is provided with the forensic mark being inserted in contents such as a video having a large sized file, a considerable time delay happens. Accordingly, currently commercialized and serviced contents having the forensic mark inserted therein are generated in advance before a request of the purchaser, and thus the digital contents having the forensic mark inserted therein do not contain information on the purchaser or information on a content transmission time.

As a method of inserting user information in the digital contents, Korean Patent Publication No. 10-2009-0079045 (Method and Apparatus for Providing Multimedia Contents Containing Watermark in Real-Time) discloses a method of preparing in advance the multimedia contents in which a watermark is inserted before a request of a user, associating identification information of the user with identification information on the contents in which the watermark is inserted when there is the request of the user, and then providing the multimedia contents. However, in this case, there is a disadvantage in that huge storage space for storing the same contents having different watermarks is required for the contents having many purchase requests, and the storage space is wasted or the contents cannot be provided when a prediction for purchase demands is not correct. Since the information on the purchaser is not directly inserted in the watermark but meaningless identification information is inserted in the watermark, an original purchaser can be traced only when a matching table between the content purchaser and the identification information is provided from each online service provider in a case where illegally shared contents are traced in the future.

### SUMMARY

The present disclosure has been made in an effort to provide a forensic marking method and a forensic marking system capable of inserting in real-time a forensic mark for user information in digital contents provided online.

An exemplary embodiment of the present disclosure provides a forensic marking method of a digital content including: generating a first content created by inserting a first forensic mark in an original content and a second content created by inserting a second forensic mark in the original content by a content server; transmitting the first and second contents to a client terminal by the content server; and combining fragments of the first and second contents in a combination order corresponding to user information to generate a third content by the client terminal

Another exemplary embodiment of the present disclosure provides a forensic marking method of a digital content including: generating a first content created by applying a first forensic mark in an original content and a second content created by applying a second forensic mark in the original content by a content server; receiving user information from a client terminal by the content server; transmitting fragments of the first and second contents corresponding to the user information to the client terminal by the content server; and combining the fragments of the first and second contents to generate a third content by the client terminal

The first and second forensic marks may have binary values of “0” and “1”, respectively.

The generating of the first and second contents may include inserting the first and second forensic marks in a unit of frames, packets, or elementary streams (ESs) of the original content, and in the generating of the third content, a combination unit of the first and second contents may be equal to an insertion unit of the first and second forensic marks.

Yet another exemplary embodiment of the present disclosure provides a forensic marking system of a digital content including: a content server configured to insert each of first and second forensic marks in an original content to generate first and second contents, and transmit the first and second contents through a network; and a client terminal configured to receive the first and second contents, and combine fragments of the first and second contents in a combination order corresponding to user information to generate a third content.

The content server may receive the user information from the client terminal, and transmit the fragments of the first and second contents corresponding to the user information to the client terminal

According to the exemplary embodiments of the present disclosure, it is possible to prevent a delay of a content service time due to an insertion of a forensic mark and quickly provide contents at a time when a user makes a request for a service. Accordingly, an aversion of a user which may be caused by the application of a content copyright protection technology can be resolved and a service provider can distribute contents having an improved copyright protection function.

Particularly, by allowing the client terminal to insert the forensic mark corresponding to user information, there is an effect of preventing loads of the server from being temporarily increased when there are many simultaneous users or there is a large sized content file such as a video and constantly maintaining a storage space of the server regardless of the number of simultaneous users.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a configuration diagram of a forensic marking system according to an exemplary embodiment of the present disclosure.

FIG. 2 is a diagram for describing a concept of combining fragments of first and second contents to generate a third content according to the exemplary embodiment of FIG. 1.

FIG. 3 is a flowchart for describing a forensic marking method according to an exemplary embodiment of the present disclosure.

FIG. 4 is a flowchart for describing a forensic marking method according to another exemplary embodiment of the present disclosure.

### DETAILED DESCRIPTION

In the following detailed description, reference is made to the accompanying drawing, which form a part hereof The illustrative embodiments described in the detailed description, drawing, and claims are not meant to be limiting. Other embodiments may be utilized, and other changes may be made, without departing from the spirit or scope of the subject matter presented here.

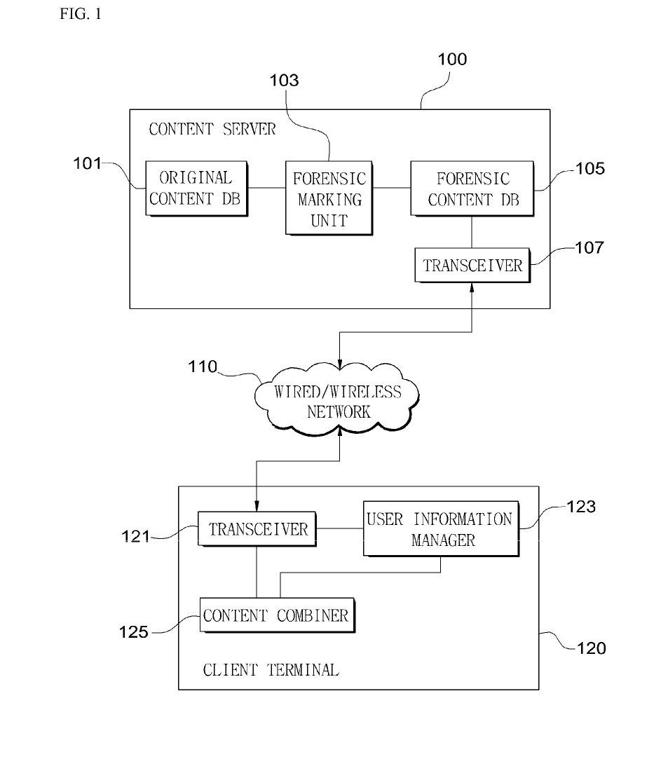

FIG. 1 is a configuration diagram of a forensic marking system according to an exemplary embodiment of the present disclosure.

Referring to FIG. 1, a forensic marking system according to an exemplary embodiment of the present disclosure includes a content server 100 for inserting each of first and second forensic marks in an original content to generate first and second contents, and transmitting the first and second contents to a client terminal 120 through a wired/wireless network 110 and the client terminal 120 for receiving the first and second contents from the content server 100, and combining fragments of the first and second contents in a combination order corresponding to user information to generate a third content.

The client terminal 120 refers to an electronic communication device which can access the content server 100 through the wired/wireless network 110 according to a key control by the user to receive various data, and corresponds to a concept including all of a personal computer (PC), a notebook, an IPTV, a smart phone, a tablet PC and the like. The wired/wireless network 110 corresponds to a concept including all networks such as a wired communication network such as a high-speed internet, a mobile communication network, a wireless local access network (WLAN) and the like that enable a plurality of communication devices to communicate with each other by connecting the communication devices wirelessly or through a wire.

The content server 100 includes an original content DB 101, a forensic marking unit 103, a forensic content DB 105, and a transceiver 107.

The original content DB 101 stores original data of various multimedia contents such as a digital sound source, a video, an image and the like provided by a content service provider. Here, a codec for encoding each of the contents may be different.

The forensic marking unit 103 generates the first content created by inserting the first forensic mark having a binary value of “0” in the original content and the second content created by inserting the second forensic mark having a binary value of “1” in the original content before a content service request of the user is generated, and stores the generated first and second contents in the forensic content DB 105.

In this case, when the original content is a video, the original content is divided into a video stream and an audio stream, and “0” and “1” are inserted in the divided streams in the forensic marking unit 103. Then, the video stream and the audio stream may be connected to a video stream DB and an audio stream DB (not shown) within the forensic content DB 105, respectively.

The forensic marking unit 103 can insert the forensic mark in all or some of sections of the original content data. Bit rates and file structures of the first and second contents in which the first and second forensic marks are inserted, respectively are the same as those of the original content. Since respective contents do not affect each other in encoding, it is possible to perform a distributed processing for each part.

The forensic marking unit 103 can insert the first and second forensic marks in the unit of frames, packets, or elementary streams (ESs) of the original content. For example, when the original content is video data, the forensic mark is inserted in the unit of ESs. When the original content is audio data, the forensic mark may be inserted in the unit of frames or packets.

The client terminal 120 includes a transceiver 121, a user information manager 123, and a content combiner 125.

Each client terminal 120 includes inherent user information for identifying users, and the user information manager 123 determines a data combination order of the first and second contents based on the user information.

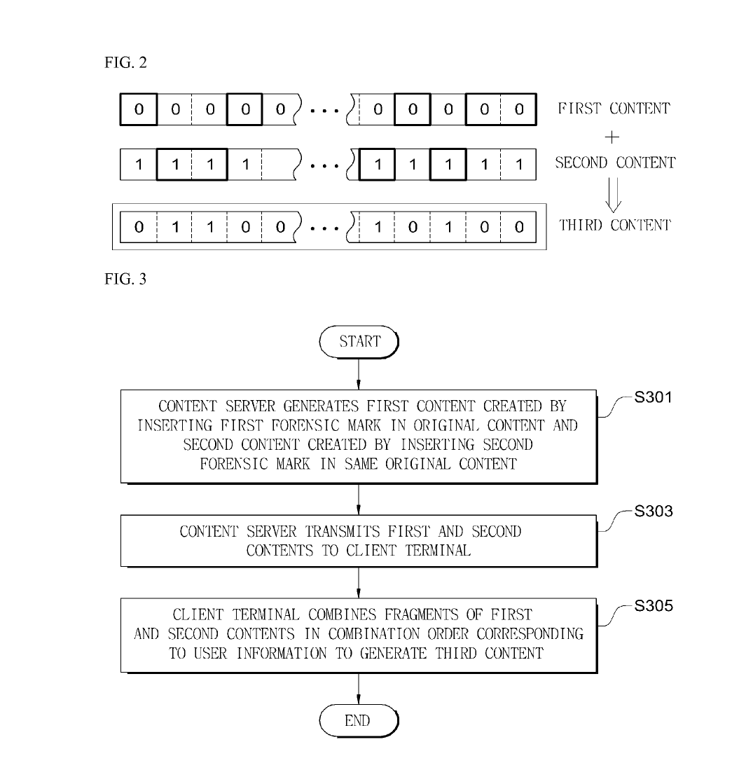

The content combiner 125 combines fragments of the first and second contents received from the content server 100 in an order corresponding to inherent user information of the client terminal 120 to generate a third content. FIG. 2 is a diagram for describing a concept of combining the fragments of the first and second contents to generate the third content according to the exemplary embodiment. As shown in FIG. 2, the third content can be generated such that signal sequences (a combination of a plurality of “0” and “1”) of different forensic marks for each user are made by combining the fragments of the first and second contents, in which different forensic mark values of “0” and “1” are inserted, in different orders according to each user information.

In this case, the combination unit of the content by the content combiner 125 may be the same as the unit in which the forensic mark is inserted by the forensic marking unit 103 of the content server 100. For example, when the forensic marking unit 103 inserts the forensic marks of “0” and “1” in the unit of ESs, the content combiner 125 can also configure the third content by combining the first content stream in which “0” is inserted in the unit of ESs and the second content stream in which “1” is inserted in the unit of ESs. A reproduction length, a bit rate, and a file structure of the third content are the same as those of the original content.

The transceiver 107 of the content server 100 and the transceiver 121 of the client terminal 120 exchange data through the wired/wireless network 110.

Meanwhile, data transmission/reception between the content server 100 and the client terminal 120 may be implemented in two manners. In a first manner, the content server 100 transmits all of the first and second content data in which the first and second forensic marks are inserted to the client terminal 120 in response to a content provision request of the client terminal 120, and the client terminal 120 selects and combines fragments of the first and second contents according to the combination order corresponding to user information to generate the third content. In a second manner, the client terminal 120 transmits inherent user information to the content server 100 in making a content provision request at the same time, and the content server 100 determines a combination order and a transmission order corresponding to the received user information and transmits fragments of the first and second contents to the client terminal 120. Both the two manners have an effect in which a side of the client terminal 120 can insert the forensic mark corresponding to the user information in the content in real-time. The first manner has an advantage of significantly reducing loads of the content server 100, and the second manner has an advantage of reducing an amount of transmitted data and thus significantly increasing transmission speed and utilization efficiency of data.

FIG. 3 is a flowchart for describing a forensic marking method according to an exemplary embodiment of the present disclosure.

Referring to FIG. 3, a forensic marking method of a digital content according to an exemplary embodiment of the present disclosure includes generating a first content created by inserting a first forensic mark in an original content and a second content created by inserting a second forensic mark in the original content by the content server 100 in step S301, transmitting the first and second contents to the client terminal 120 by the content server 100 in step S303, and combining fragments of the first and second contents in a combination order corresponding to user information to generate a third content by the client terminal 120 in step S305.

Here, the first and second forensic marks inserted in the original content may have binary values of “0” and “1”, respectively.

In step S301, the first and second forensic marks can be inserted in all or some of sections of the original content. The first and second forensic marks can be inserted in the unit of frames, packets, or ESs of the original content.

In step S303, the content server 100 transmits all of first content data and second content data to the client terminal 120.

In step S305, a combination unit of the first and second contents may be the same as an insertion unit of the first and second forensic marks.

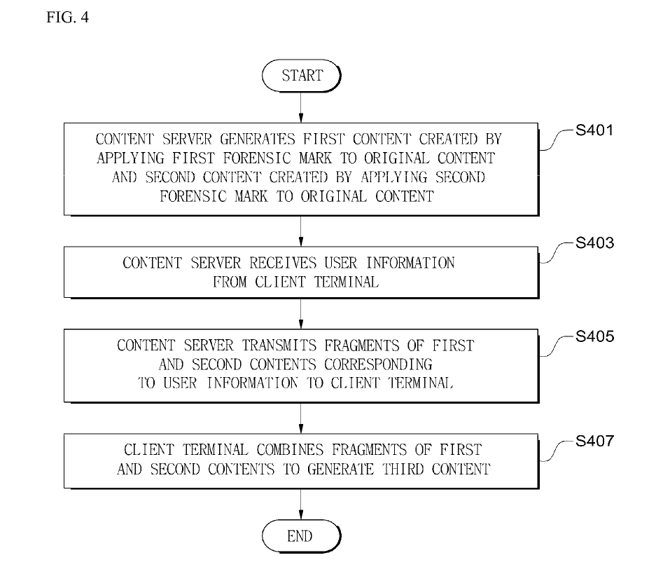

FIG. 4 is a flowchart for describing a forensic marking method according to another exemplary embodiment of the present disclosure.

Referring to FIG. 4, a forensic marking method according to another exemplary embodiment of the present disclosure includes generating a first content created by applying a first forensic mark to an original content and a second content created by applying a second forensic mark to the original content by the content server 100 in step S401, receiving user information from the client terminal 120 by the content server 100 in step S403, transmitting fragments of the first and second contents corresponding to the user information to the client terminal 120 by the content server 100 in step S405, and combining the fragments of the first and second contents to generate a third content by the client terminal 120 in step S407.

In the exemplary embodiment of FIG. 4, the content server 100 does not transmit all of first content data and second content data to the client terminal 120, but the client server 120 first transmits information on a combination order of the data based on the user information to the content server 100 in step S403. Subsequently, the content server 100 selects the fragments of the first and second contents according to a combination order corresponding to the user information received from the client terminal 120 and transmits the selected fragments to the client terminal 120 in step S405, and the client terminal 120 combines the received fragments of the first and second contents to generate the third content in a form in which the forensic mark corresponding to the user information is inserted in step S407.

A more detailed forensic marking method of the digital content according to the present disclosure and its effects are the same as those described through FIGS. 1 and 2 above.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A forensic marking method of a digital content comprising:
generating a first content created by inserting a first forensic mark in an original content and a second content created by inserting a second forensic mark in the original content by a content server;
transmitting the first and second contents to a client terminal by the content server; and
combining fragments of the first and second contents in a combination order corresponding to user information to generate a third content by the client terminal

2. The forensic marking method of claim 1, wherein the first and second forensic marks have binary values of “0” and “1”, respectively.

3. The forensic marking method of claim 1, wherein the generating of the first and second contents comprises inserting the first and second forensic marks in all or some of sections of the original content.

4. The forensic marking method of claim 1, wherein the generating of the first and second contents comprises inserting the first and second forensic marks in a unit of frames, packets, or elementary streams (ESs) of the original content.

5. The forensic marking method of claim 4, wherein, in the generating of the third content, a combination unit of the first and second contents is equal to an insertion unit of the first and second forensic marks.

6. The forensic marking method of claim 1, wherein the original content and the first, second and third contents have an equal reproduction length, bit rate and file structure.

7. A forensic marking method of a digital content comprising:
generating a first content created by applying a first forensic mark in an original content and a second content created by applying a second forensic mark in the original content by a content server;
receiving user information from a client terminal by the content server;
transmitting fragments of the first and second contents corresponding to the user information to the client terminal by the content server; and
combining the fragments of the first and second contents to generate a third content by the client terminal

8. The forensic marking method of claim 7, wherein the first and second forensic marks have binary values of “0” and “1”, respectively.

9. The forensic marking method of claim 7, wherein the generating of the first and second contents comprises inserting the first and second forensic marks in a unit of frames, packets, or elementary streams (ESs) of the original content.

10. The forensic marking method of claim 9, wherein, in the generating of the third content, a combination unit of the first and second contents is equal to an insertion unit of the first and second forensic marks.

11. A forensic marking system of a digital content comprising:
a content server configured to insert each of first and second forensic marks in an original content to generate first and second contents, and transmit the first and second contents through a network; and
a client terminal configured to receive the first and second contents, and combine fragments of the first and second contents in a combination order corresponding to user information to generate a third content.

12. The forensic marking system of claim 11, wherein the content server receives the user information from the client terminal, and transmits the fragments of the first and second contents corresponding to the user information to the client terminal

13. The forensic marking system of claim 11, wherein the first and second forensic marks have binary values of “0” and “1”, respectively.

14. The forensic marking system of claim 11, wherein the content server inserts the first and second forensic marks in all or some of sections of the original content to generate the first and second contents.

15. The forensic marking system of claim 11, wherein the content server inserts the first and second forensic marks in a unit of frames, packets, or elementary streams (ESs) of the original content to generate the first and second contents.

16. The forensic marking system of claim 15, wherein a combination unit of the first and second contents by the client terminal is equal to an insertion unit of the first and second forensic marks.

17. The forensic marking system of claim 11, wherein the original content and the first, second and third contents have an equal reproduction length, bit rate and file structure.
